(19) United States
(12) Patent Application Publication
(10) Pub. No.: US 2018/0060042 A1
(43) Pub. Date: Mar. 1, 2018

(54) NoLeftContextMenu.js

(71) Applicant: Kim Loan Choate, Las Vegas, NV (US)

(72) Inventor: Kim Loan Choate, Las Vegas, NV (US)

(21) Appl. No.: 15/247,882

(22) Filed: Aug. 25, 2016

(51) Int. Cl. G06F 9/44

(52) U.S. Cl. CPC G06F 8/31

(57) ABSTRACT

What is new in the art to which my invention pertains is that the Javascript Source Code of NoLeftContextMenu.js allows that the left Context Menu box does not pop up on the webpage when visitors visit a domain. This allows that the visitor cannot as easil highlight an image file, copy and save it to their computer, print the page, nor see the pages source code by using the right click feature of the mouse, unless otherwise using the top toolbars instead.

### BACKGROUND

Stunning Designs Biz's owner, Kim Loan Choate, hereby requests a U.S. Patent for my Source Code script with file name NoLeftContextMenu.js combined with Javascript for right click pop-up of a box to display Copyrights or comments. If you visit any major websites online today, you will find that websites, examples of Google, Microsoft, Yahoo, and all government websites, do not have this feature. When you are on the internet exploring websites if you right click with your mouse a left box pops up, the Context Menu. My source code prevents the left Context Menu box from popping up, and provides a right pop-up box where Copyrights or comments can be displayed instead. The pop-up source code is stored as a Javascript at the bottom of any source code outside of the HTML source code, unlike any other similar code. Combined with the NoLeftContextMenu.js script which the Javascript link is provided inside of the HTML source code yet not in the heading and not in the body, but instead under the body TAG and before the html TAG ends. By having the NoLeftContextMenu.js script in a separate file outside of the Source Code provides that the script is kept private for only licensed users. It is the placement and location of the source code script that allows it to be highly compatible with most of the latest technologies.

The HTML webpage source code is provided herein, along with the external Javascript, to be U.S. Patented under Stunning Designs Biz's owner, Kim Loan Choate. VIEW DESCRIPTION:

### SPECIFICATIONS

(2 pages) Stunning Designs Biz's owner, Kim Loan Choate, hereby provides a DETAILED, WRITTEN DESCRIPTION of the HTML webpage Source Code that prevents the left Context Menu box from popping up on webpages and allows for a right pop-up box to appear to display Copyrights or comments instead in a version compatible with most technologies. CODES:

<html>
<head>
<title>NO CONTEXT MENU BOX!</title>
</head>
<body>
Try to right click with your mouse anywhere on this page,<br>
and no left context menu box will appear!<br>
A right pop-up box appears instead, and in the box<br>
the website can place Copyrights or comments for visitors to see.<br>
</body>
<script type=“text/javascript” src=“NoLeftContextMenu.js”></script>
</html>
<script language=“javascript”>
function click( ) {
if (event.button==2) {
alert(‘Copyrights [place your website name or comments here]. All Rights
Reserved.’)
}
}
document.onmousedown=click
</script>
//Script Source Code for: NoLeftContextMenu.js (no line spaces between
on actual code page)
if (window.Event)
document.captureEvents(Event.MOUSEUP);
function nocontextmenu( )
{
event.cancelBubble = true
event.returnValue = false;
return false;
}
function norightclick(e)
{
if (window.Event)
{
if (e.which == 2 ∥ e.which == 3)
return false;
}
else
if (event.button == 2 ∥ event.button == 3)
{
event.cancelBubble = true
event.returnValue = false;
return false;
}
}
document.oncontextmenu = nocontextmenu;
document.onmousedown = norightclick;

To test script, add Page 2 to an HTML Source Code and add Page 3 Javascript Source Code to a page in Notepad and save it as “NoLeftContextMenu.js” while placing both files in same folder Then open the HTML file in Internet Explorer and right click the button on your mouse pad.

### SUMMARY

The above two files are available to show how the Source Codes function. Place both files in the same file folder. Open the sample HTML file in Internet Explorer, then right click with your mouse. You will see that the left Context Menu does not pop up and that a right Copyrights or comments box pops up instead. The right Copyrights or comments box that pops up does not necessarily have to be in the HTML Source Code if it is preferred not to have it, but it is an added bonus. The U.S. Patent is for the website Source Codes scripts locations in the HTML Source Code and Javascripts that allow this function or no left Menu Context box to occur. To view the actual Source Code sample of NoLeftContextMenu.js you may open it with Notepad in laptop.

To further test that these Source Codes scripts are unique and compatible with most technologies, open other websites, Google, Microsoft, Yahoo, government sites, and right click with your mouse. You will see that a left Context Menu pops up, and no right Copyrights or comments box does. Try the sample HTML file in many types of laptops or devices. The U.S. Patent for “No Left Context Menu but Yes Right Box Copyrights or comments” for Stunning Designs Biz, owner Kim Loan Choate, is requested with all due sincerity.

1. Stunning Designs Biz's owner, Kim Loan Choate, and inventor of NoLeftContextMenu.js Source Code defines the scope of the protection of the Patent herein for this Claim.
Any domain that wishes to use the Javascript Source Code of NoLeftContextMenu.js may purchase a License to use it through stunningdesigns.biz website. Website hosts may also purchase multi-domain licenses to use the Source Code through stunningdesigns.biz if it is a feature that is useful for its web pages or domain users to not have the left Context Menu box pop up when the right button is pressed on the mouse pad.
The protection of the U.S. Patent is so that the Javascript Source Code of NoLeftContextMenu.js is not freely used without a License from the inventor on domains that do not purchase a License or that does not have multi-domain Licenses through its website's host that are purchased from the inventor by the website's host.
